(19) United States
(12) Patent Application Publication
(10) Pub. No.: US 2009/0089333 A1
(43) Pub. Date: Apr. 2, 2009

(54) Method and system for analyzing operating condition

(75) Inventor: Yasunori Kobayashi, Muisashino-Shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 12/286,622

(22) Filed: Oct. 1, 2008

(30) Foreign Application Priority Data
Oct. 1, 2007 (JP) 2007-257192

(51) Int. Cl. G06F 17/30

(52) U.S. Cl. 707/104.1; 707/E17.009

(57) ABSTRACT

An apparatus has an information collecting section serving as information acquisition section that collects data which are to serve as original data for an index value and a report receiving section that receives a report. A report preparation system has an index value receiving section that receives an index value transmitted from the apparatus; an index value storage section that stores received index values; an index value analysis section serving as analysis section that performs predetermined analysis by use of the stored index values; a report preparation section that makes up a report on the basis of a result of analysis performed by the index value analysis section; a report storage section that stores prepared reports; and a report transmission section that transmits, as required, the stored reports.

### TECHNICAL FIELD

The present disclosure relates to a method and system for analyzing an operating (use) condition an apparatus introduced to a production site.

### RELATED ART

Field equipment, such as a sensor, an analyzer, and a control valve, and various types of apparatus (various devices and systems), such as a distributed control system, a network control system, a safety instrumented system, an asset management system, a plant information management system, and an production management system, are developed and manufactured by specific developers or manufacturers. The apparatus is introduced to production sites (hereinafter simply called “sites”) of a variety of clients.

[Patent Document 1] Japanese Patent Unexamined Application Publication No. 2004-21712

However, under the current circumstances, the apparatus does not have any function of calculating and displaying, as index values, the extent to which a feature provided by the apparatus is effectively utilized. For instance, a distributed control system has, as principal functions, a control function and a monitoring function. The distributed control system does not have the function of calculating and displaying index values showing whether or not the control function is effectively utilized (e.g., an hourly-integrated deviation per PID control loop, a closed rate of a PID control loop to be automatically controlled, and the like). The distributed control system does not have the function of calculating and displaying index values showing whether or not a monitoring function is effectively utilized (e.g., an integrated number of screen touches per board operator), either.

Therefore, a client cannot readily ascertain to what extent features of respective apparatuses purchased and used by the client are effectively utilized. In order to ascertain the degree of utilization, the client must calculate the degree of utilization manually or prepare a calculating application for itself. Further, some of such index values must be calculated by use of internal data hidden in each apparatus, and hence the client cannot calculate such index values by itself. As mentioned above, since it is not easy to ascertain whether or not the features of the apparatus purchased and used by the client are effectively utilized, the client cannot feel a necessity for improving the degree of utilization. Because of a decrease in the degree of utilization, the apparatus cannot sufficiently exhibit the features, and a production loss, or the like, may have already arisen. As a matter of course, data pertaining to another corporation using a similar apparatus cannot be acquired. As things stand now, there is no business entity that provides comparative analysis service concerning the degree of utilization, and the like, so that a comparison of the client to competitors cannot be analyzed, too.

In order to perform effective analysis, various information belonging to a provider of an apparatus that develops, manufactures, and sells the apparatus is required. In fact, there is also a reason that a sufficient effect cannot be achieved by the analysis performed by the third party other than the provider of the apparatus.

### SUMMARY

Exemplary embodiments of the present invention provide a method and system for analyzing an operating condition of an apparatus, which enable easy ascertainment of the degree of utilization, and the like, by analysis of operating conditions of the apparatus.

A method for analyzing operating condition of an apparatus according to an exemplary embodiment of the present invention comprises steps of: acquiring, from the apparatus, information required to analyze the operating condition; and collecting the information acquired in the step of acquiring the information and analyzing the operating condition of the apparatus at a provider of the apparatus by use of the collected information.

According to the operating condition analyzing method, the provider of the apparatus analyzes operating conditions of the apparatus by use of the information acquired from the apparatus. Therefore, the degree of utilization of the apparatus, and the like, can be readily ascertained on the basis of a result of analysis.

The operating condition analyzing method may also include a step of notifying a user of the apparatus of a result of analysis of the operating condition acquired in the step of analyzing the operating condition.

In the step of analyzing an operating condition, comparative analysis of operating conditions of the plurality of apparatuses may also be performed.

The operating condition may also relate to a degree of utilization of the apparatus.

A system for analyzing operating condition of an apparatus according to an exemplary embodiment of the present invention comprises: an information acquisition section which acquires, from the apparatus, information required for analysis of the operating condition performed at a provider of the apparatus.

According to the operating condition analyzing system, the provider of the apparatus can analyze operating conditions of the apparatus by use of the information acquired from the apparatus, and hence the degree of utilization of the apparatus, and the like, can be readily ascertained on the basis of a result of analysis.

The operating condition analyzing system may also include an analysis section which collects the information acquired by the information acquisition section and that analyzes operating condition of the apparatus at the provider of the apparatus by use of the collected information.

The analysis section may also perform comparative analysis of operating conditions of the plurality of apparatuses.

The operating condition may also relate to a degree of utilization of the apparatus.

Other features and advantages may be apparent from the following detailed description, the accompanying drawings and the claims.

### BRIEF DESCRIPTION OF THE DRAWINGS

FIG. 1 is a view showing the concept of an operating condition analyzing method of an embodiment;

FIG. 2 is a block diagram functionally showing the configuration of an introduced apparatus and the configuration of a report preparation system; and

FIG. 3 is a block diagram showing an example in which a portion of an index value submission function is provided outside of the apparatus.

### DETAILED DESCRIPTION

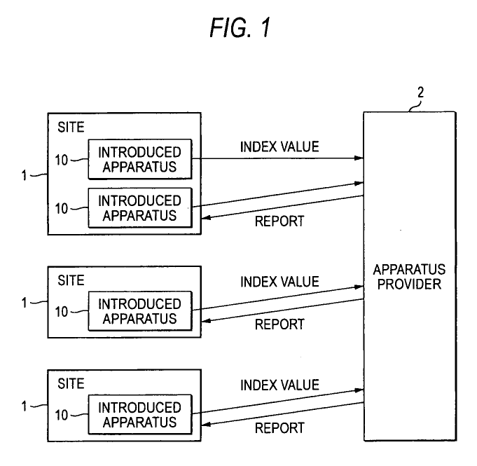

By reference to FIGS. 1 through 3, an embodiment of an operating condition analyzing method of the present invention will be described hereunder.

FIG. 1 is a view showing the concept of an operating condition analyzing method of the embodiment.

As shown in FIG. 1, in the embodiment, operating conditions of apparatuses 10, 10, . . . , introduced into sites 1, 1, . . . , are analyzed. An apparatus provider 2 collects index values required to analyze the degree of effective utilization of the apparatuses 10, 10, from the apparatus 10, 10, . . . introduced into the sites 1, 1, . . . . The apparatus provider 2 analyzes the degree of effective utilization of the apparatus by use of the index values, to thus make out a report. The apparatus provider 2 is; for instance, the developer, manufacturer, or sales company of the apparatus 10, 10, . . . .

The analysis result pertaining to the degree of effective utilization is notified as a report to the client of the apparatus. An address of the report is; for instance, each of the clients who purchased the respective apparatuses 10. The report represents an evaluation result pertaining to the degree of effective utilization of the apparatus 10 or a system including the apparatus 10, . . . , 10; for instance, for each apparatus 10, for each system including the apparatus 10, for each site 1, such as a plant, or for each client.

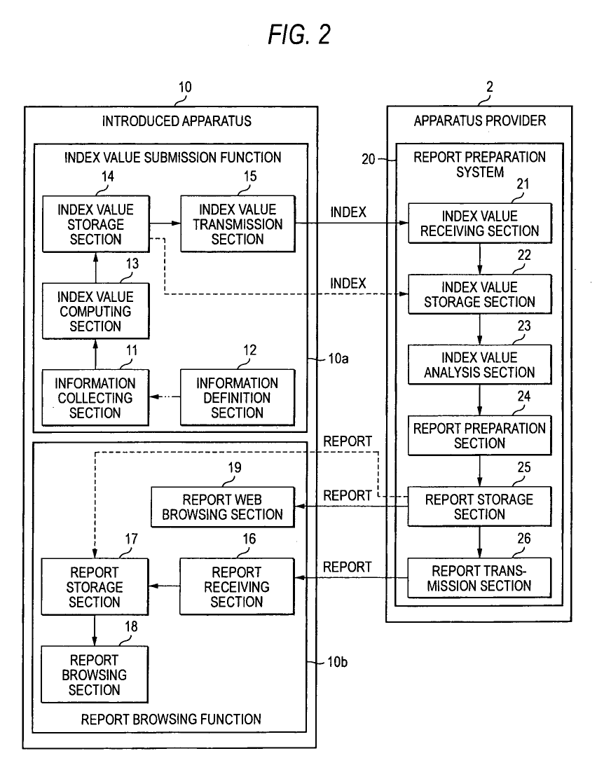

FIG. 2 is a block diagram functionally showing configurations of the apparatus 10 and a report preparation system that are applied to the operating condition analyzing method of the present embodiment.

As shown in FIG. 2, the apparatus 10 introduced into the site has an index value submission function 10a and a report browsing function 10b.

The apparatus 10 has, as elements constituting the index value submission function 10a, an information collecting section 11; an information definition section 12; an index value computing section 13; an index value storage section 14; and an index value transmission section 15. The information collecting section 11 serves as information acquisition section that collects data which are to act as original data for an index value. The information definition section 12 defines data to be collected by the information collecting section 11 by means of a tag name, or the like, used in the apparatus 10. The index value computing section 13 computes an index value on the basis of the data collected by the information collecting section 11. The index value storage section 14 stores computed index values. The index value transmission section 15 transmits, as required, a stored index value.

The apparatus 10 has, as elements constituting the report browsing function 10b, a report receiving section 16 that receives a report; a report storage section 17 that stores a received report; a report browsing section 18 that browses a stored report; and report WEB browsing section 19 for browsing a report by utilization of a WEB service.

In the meantime, the apparatus provider 2 has a report preparation system 20.

A client granted a permission by the apparatus provider 2 may have the report preparation system 20, or the apparatus 10 may also be configured to be provided with the report preparation system 20.

As shown in FIG. 2, the report preparation system 20 has an index value receiving section 21; an index value storage section 22; an index value analyzing section 23; a report preparation section 24; a report storage section 25; and a report transmission section 26. The index value receiving section 21 receives an index value transmitted from the apparatus 10. The index value storage section 22 stores a received index value. The index value analyzing section 23 serves as analyzing section that performs an analysis by use of a stored index value. The report preparation section 24 makes up a report on the basis of a result of analysis performed by the index value analyzing section 23. The report storage section 25 stores a prepared report. The report transmission section 26 transmits, as required, a stored report.

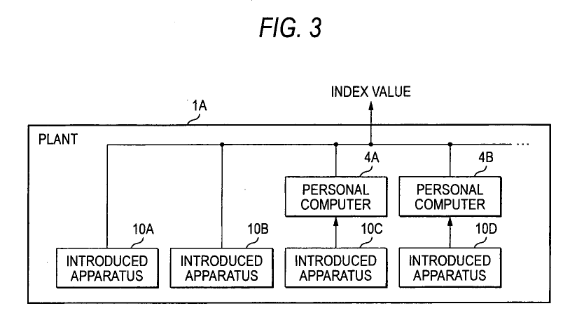

FIG. 3 shows an example in which a portion of the index value submission function is disposed outside of the apparatus. In FIG. 3, an apparatus 10A and an apparatus 10B introduced to a plant 1A are provided with the index value submission function, and directly transmit index values. In contrast, an apparatus 10C and an apparatus 10D are not provided with the index value submission function, and an external personal computer 4A and an external personal computer 4B constitute portions of the index value submission function. As mentioned above, the index value submission function can also be provided in an external apparatus.

The report browsing function may not be provided in the apparatus 10 but provided in another apparatus, instead. In this case, the report is to be transmitted to an apparatus having the report browsing function. Further, no limitation is imposed on the destination of transmission or the address of the report, and the report may be provided to a destination defined by a contract, and the like.

Operation of the apparatus 10 and operation of the report preparation system 20 will now be described.

The information collecting section 11 of the apparatus 10 collects data in accordance with specifics of definitions in an information definition section 12. Data to be collected are process data, alarm messages, event messages, internal data pertaining to the apparatus, user definition data, and the like.

The internal data pertaining to the apparatus are data that are meaningless for the client even when viewed, as they are, by the client, and are not disclosed to the client. The internal data include; for instance, a screen ID showing a switched state of a screen, a quality code of data, the number of alarms being issued, and the like.

Further, the user definition code includes; for instance, the hierarchical structure of a plant input by the user (the client), the number of connected input/output devices, and the like.

The information collecting section 11 positively collects data at a given period and passively collects data in association with occurrence of an event. A collecting method varies according to the type of data.

The index value computing section 13 computes various index values from the data collected by the information collecting section 11. Further, the index value computing section 13 also performs integration of such computed values. An integrated value is used as a new index value (an index value per unit time).

The index value storage section 14 stores index values in predetermined periodic units. For instance, in addition to an hourly basis, a daily basis, a weekly basis, and an annual basis, a per-operation-shift (work-shift) basis or a per-batch basis at a batch process are used as periodic units conforming to respective index values.

The index value transmission section 15 transmits the index value stored in the index value storage section 14 to the report preparation system 20 at a predetermined period (daily, weekly, monthly, annually, and the like). The Internet, another public line, or a private line, can be used as a transmission path for an index value.

In the meantime, the index value receiving section 21 of the report preparation system 20 receives the thus-transmitted index value. The index value storage section 22 stores the received index value in predetermined periodic units. Periodic units conforming to respective index values correspond to the periodic units employed by the index value storage section 14 during a period of storage.

The index value stored in the index value storage section 14 can also be imparted to the report preparation system 20 by means of an electronic mail or carrying a recording medium in place of transmission of the index value performed by the index value transmission section 15. In this case, the index value is stored directly in the index value storage section 22.

Next, the index value analyzing section 23 performs analysis in accordance with an index value stored in the index value storage section 22.

Data corresponding to an index value are normalized and then subjected to comparative analysis. As a result, more rational, statistical processing of an index value, making of an appropriate evaluation of a report, and the like, are enabled. The following are mentioned as elements (acting also as index values) used for normalization processing.

(1) A process unit or a plant hierarchy
(2) The number of input/output devices connected to the apparatus 10 (the number of analogue inputs, the number of analogue outputs, the number of digital inputs, and the number of digital outputs). For instance, the plant hierarchy and a monitoring area is reflected on the evaluation of the numeral.
(3) The number of operation modes, and types of operation modes
(4) The number of alarms defined in the apparatus. For instance, a plant hierarchy, a monitoring area, alarm priority, and an alarm format are reflected on the evaluation of the numeral.
(5) The number of PID loops. For instance, besides the plant hierarchy and the monitoring area, the degree of complexity, such as whether a loop is a single loop or a cascade loop, and the like, is reflected on the evaluation of the numeral.
(6) The number of APC loops
(7) The number of operation shifts (the number of work shifts)
(8) The number of board operators (the number of operators assigned to a monitoring terminal). For instance, the number of operation shifts (the number of work shifts) is reflected on the evaluation of the numeral.

The index value can be selected, as required. However, in view of evaluation of RASIS (Reliability, Availability, Serviceability, Integrity, and Security), the follows are mentioned as index values to be subjected to comparative analysis. These factors can be evaluated; for instance, for each component, for each card (circuit), or for each monitoring apparatus.

(1) Reliability

Mean Time Between Failures=Operating time/the number of failures
Accuracy: for instance, accuracy achieved except a time when an operating time/data quality code is good and a time at which no alarm is issued.

Factors responsible for deterioration of reliability include; for instance, a bad installation environment, a wrong usage, low product quality, low frequency of calibration, and the like.

(2) Availability

Availability factor=mean time between failures/(mean time between failures+mean time to repair)

(3) Serviceability

Mean time to repair=repair time/the number of failures

Factors responsible for deterioration of availability include; for instance, poor service quality, a remote service depot, low skill of a serviceman, and the like.

(4) Integrity

Corruption of data, which would otherwise be caused accidentally or intentionally, does not arise. Even if data get corrupted, the data can be recovered or not. Further, exclusive control, error control, and the like, is available. Factors responsible to deterioration of serviceability and integrity include; for instance, lack of a system or countermeasures.

(5) Security

The frequency of occurrence of an invalid access or leakage of information. Factors responsible to deterioration of security include lack of security measures, low morale of employees, and the like.

From the viewpoint of controllability, the following index values can be mentioned for instance.

(6) An (daily) integrated deviation from control set point by each control loop. Factors responsible for deterioration of an evaluation include a tuning failure of a controller, a design failure of the control loop, a design failure of a process, and the like.

(7) A total time in one day during which a specific control value (CV) is controlled by means of automatic control operation (i.e., is not switched to manual operation). Factors responsible for deterioration of an evaluation include unstable control and creation of a control loop that does not require control.

(8) A total time in one day during which the control value (CV) is in a controllable state. Factors responsible for deterioration of an evaluation include a range over attributable to the manner of ranging and the size of a pipe, an instrument failure, a communication failure, and the like.

(9) A total time in one day during which a specific control value (CV) is controlled by means of automatic control operation and during which the value falls within an allowable range corresponding the preset value or a preset range. Factors responsible for deterioration of an evaluation include a tuning failure of a controller, a design failure of a control loop, a design failure of a process, and the like. When compared with the index value (6), the index value is easy to compute.

The following index values are mentioned in view of process-monitoring operation.

(10) The number of times a screen is extended. The index value corresponds to the frequency of operation and is computed for each shift time (working time) of an operator.

The following index values are mentioned from the viewpoint of tracking or monitoring of an alarm.

(11) The number of defined alarms by alarm priority. Excessive definition of constant alarm priority contributes to deterioration of an evaluation of the index value.

(12) A definition ratio for each alarm priority. Indiscriminately assigning an alarm priority contributes to deterioration of an evaluation of the index value.

(13) The number of alarms in each working hour of an operator

(14) The number of emergency alarms in one day

(15) The number of alarms recovered in one day without acknowledgement of an operator (i.e., without acknowledgement operation of the operator)

(16) The number of alarms continued for a long period of time in one day

(17) The number of specific alarms occurred many times in one day

Further, the following index values are mentioned from the viewpoint of intervention of manual operation during the course of automatic control operation.

(18) The number of manual operations. The index value is computed daily or for each operator's shift. When there is a control loop difficult to automatically control, evaluation of the index value is deteriorated.

(19) The number of operations for intervening in a preset value (a target value). The index value is computed daily or for each operator's shift. When the frequency of alteration in operating condition is high or when an operator is repeating useless operation, evaluation of the index value is deteriorated.

(20) The number of operations for intervening in an alarm threshold value. The index value is computed daily or for each operator's shift. When the degree of alteration in operating conditions is high or when an alarm threshold value is not optimized, evaluation of the index value is deteriorated.

Next, the report preparation section 24 (FIG. 2) makes up, on the basis of a result of analysis performed by the index value analyzing section 23, a report intended for a client, and the thus-made report is stored in the report storage section 25.

The report transmission section 26 acquires a corresponding report from the report storage section 25 and transmits the report to the client periodically; for instance, daily, weekly, monthly, or annually. The Internet, another public line, or a private line, can be used as a transmission channel for a report.

In the meantime, the report receiving section 16 of the apparatus 10 receives a transmitted report. The report storage section 17 stores the thus-received report. The client can browse the report stored in the report storage section 17 by use of the report browsing section 18. Further, the client can also directly browse a report, which is stored in the report storage section 25 of the report preparation section 20 and addressed to the client, by use of a report WEB browsing section 19.

The report stored in the report storage section 25 can also be presented to the client by means of an electronic mail or carrying a recording medium instead of transmitting a report through use of the report transmission section 26. In this case, the report is stored directly in the report storage section 17.

A report that is made up by the report preparation section 24 and that is submitted to the client includes the degree of effective utilization of the apparatus 10 made up of a measuring apparatus, a control apparatus, and an information apparatus. The degree of effective utilization can be indicated as evaluations determined by comparison with benchmarks. There can also be provided data pertaining to a comparison of an evaluation with evaluations of competitors, evaluations of client's other sites (or plants), or client's evaluations acquired in the past. Thereby, it is possible for the client to objectively and readily ascertain the extent to which the introduced apparatus fulfills the objective of introduction.

For instance, the client introduced the distributed control system can ascertain the current controllability and monitoring efficiency with regard to improvements in controllability and monitoring efficiency which are objectives of introduction of the system, and can ascertain the extent to which controllability and monitoring efficiency have been enhanced as compared with the past, as well. The client can also ascertain the degrees of achieved controllability and monitoring efficiency compared with those achieved in other sites (or plants) or by other apparatus of the client or with those achieved in analogous sites (or plants) or by analogous apparatus of competitors.

Further, in relation to the apparatus that cannot be effectively utilized, the client can ask performance of consultation from the provider of the apparatus on the basis of such a report in order to achieve enhanced utilization. The client can receive consultation in which a process and operations are taken into account.

In the meantime, from the standpoint of the apparatus provider, the client perfectly, effectively utilizes various delivered measurement, control, and information apparatus as a result of submission of the report to the client, so that the client can properly evaluate the products and that the client's feeling of satisfaction can be enhanced.

As described above, according to the operating condition analyzing method of the present invention, the provider of the apparatus analyzes operating conditions of the apparatus by use of information acquired from the apparatus and therefore can readily ascertain the degree of utilization of the apparatus, or the like, on the basis of a result of analysis of the operating conditions.

The range of application of the present invention is not limited to the above embodiment. The present invention can be widely applied to the operating condition analyzing method for analyzing operating condition of an apparatus and an operating condition analyzing apparatus.

What is claimed is:

1. A method of analyzing operating condition of an apparatus, comprising steps of:
acquiring, from the apparatus, information required to analyze the operating condition; and
collecting the information acquired in the step of acquiring the information and analyzing the operating condition of the apparatus at a provider of the apparatus by use of the collected information.

2. The operating condition analyzing method according to claim 1, further comprising a step of:
notifying a user of the apparatus of a result of analysis of the operating condition acquired in the step of analyzing the operating condition.

3. The operating condition analyzing method according to claim 1, wherein in the step of analyzing the operating condition, comparative analysis of operating conditions of the plurality of apparatuses is performed.

4. The operating condition analyzing method according to of claim 1, wherein the operating condition relates to a degree of utilization of the apparatus.

5. A system for analyzing operating condition of an apparatus, comprising:
an information acquisition section which acquires, from the apparatus, information required for analysis of the operating condition performed at a provider of the apparatus.

6. The operating condition analyzing system according to claim 5, further comprising:
an analysis section which collects the information acquired by the information acquisition section and analyzes the operating condition of the apparatus at the provider of the apparatus by use of the collected information.

7. The operating condition analyzing system according to claim 6, wherein the analysis section performs comparative analysis of operating conditions of the plurality of apparatuses.

8. The operating condition analyzing system according to claim 5, wherein the operating condition relates to a degree of utilization of the apparatus.
